(19) United States
(12) Patent Application Publication
(10) Pub. No.: US 2002/0025833 A1
(43) Pub. Date: Feb. 28, 2002

(54) Method for telephone communication between a portable object with horological functions and telephone and a dedicated server, and portable object for implementation of the same

(76) Inventors: Jean-Claude Martin, Neuchatel (CH); Sergio Rota, Neuchatel (CH)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/931,067

(22) Filed: Aug. 17, 2001

(30) Foreign Application Priority Data
Aug. 24, 2000 (CH) 1648/00

(51) Int. Cl. H04M 1/00

(52) U.S. Cl. 455/556; 455/566; 455/456

(57) ABSTRACT

The method for telephone communication between at least one portable object, such as a mobile telephone-watch (1), and a dedicated server (2) for the two-way transmission of data signals for the horological functions (6, 7) includes the steps of connecting the mobile telephone unit (27) of the portable object (1) to a mobile telephone network, establishing a telephone link between the server (2) and the portable object (1), transmitting data signals between the server (2) and the portable object (1) to adjust and/or update the horological functions of the object, and to correct the horological functions of said object on the basis of the data signals which have been received and shaped.

The invention concerns a method for telephone communication between a portable object, which includes horological functions, particularly for indicating the time and a mobile telephone unit, and a dedicated server for the two-way transmission of data signals relating to the horological functions. The invention also concerns a portable object for implementing the above method.

The exchange of data which occurs during telephone communication between the portable object and the server mainly concerns the transmission of data relating to the horological functions of said object, but this exchange also concerns the transmission of acoustic or vocal data signals or message signals. The portable object is of comparable size to a conventional wireless mobile telephone or a watch, for example a wristwatch.

The horological functions of the portable object concern both the elements for indicating the local time or Internet time, the date or Internet date or at least an alarm time, as well as software modules relating to various alarm melodies, controlling electronic components for indicating the time, a selection of time zones, adjusting the oscillator or the time-keeping circuit's time base or other functions commonly found in watches.

Within the field of telephone systems, several devices have already been proposed for providing data signals other than the conventional vocal or acoustic telephone communication signals. The data transmitted is for example short information messages which are displayed on display devices of the telephone apparatus or time data. The data signals transmitted between two telephone apparatus are of the electric type in wired networks or of radio-frequency type in the mobile telephone systems which is the case with a portable object including a mobile telephone.

Correction via telephonic means of the time reading of an electronic watch was for example proposed in British Patent No. 2 100 890. The electronic watch disclosed in this document includes means for periodically connecting said watch automatically to a standard time signal provided by a telephone system, and means for automatically synchronising said watch with the standard time signal. This first watch, which includes in particular a telephone and means for dialling a telephone number, is connected to telephone communication lines in order to receive the standard time signal provided by a speaking clock. The signals received by the first watch are used first of all for setting the time, and also for setting the time of other watches connected to the first watch.

One drawback of this type of watch is that it has to be connected to a telephone line only to receive the time data in order to correct the time which it displays. Said watch is not provided for an exchange of data with the speaking clock. Moreover, the data signals are acoustic signals which have to be converted into electric signals which are comprehensible to the watch which means that a conversion unit has to be added to said watch.

Another drawback of this type of watch is the fact that the time displayed by the watch can only be set at a location where it is possible for it to be connected to the telephone lines.

In the same technical context of adjusting the time of a watch, Swiss Patent No. 589 886 proposes setting the time of a watch automatically by moving it close to a telephone handset to receive the acoustic time signals from a speaking clock or magnetic coupling with a transformer integrated in the telephone apparatus.

As for the preceding document, a major drawback is that it is only possible to adjust the time of this watch at a location where there is a standard fixed telephone apparatus connected to a telephone line. Moreover, the acoustic or magnetic signals for adjusting the time still have to be converted into electric signals which are comprehensible to said watch.

Japanese Patent No. 5-130256 discloses a time data correction system for a calling device. The calling device must first of all automatically dial the number of an equipment centre which will compare the time data provided by said calling device and thus provide it in return with correct time data in order to make an automatic correction. This data transfer occurs via a telephone line network.

The calling device is not comparable to a portable object of small size, such as a mobile telephone or a watch, but only to an apparatus which includes a time-keeping circuit solely for the purpose of allowing the time to be corrected between two communicating apparatus. One drawback is that the time correction can only be made at the place where said devices are connected and one has to know the time difference between the calling device and the called device once the devices have been connected.

International Patent Application No. WO 91/11875 discloses a combination of a telephone handset and a wristwatch which includes means for receiving messages, such as telephone numbers, means for storing telephone numbers, and means for providing the stored telephone numbers to the telephone handset in order to make a telephone call. In this embodiment, the telephone handset does not include any dial keys for the telephone numbers stored in the wristwatch. These telephone numbers can be supplied to the handset automatically.

The wristwatch thus acts in this embodiment as a telephone directory in order to transmit the telephone numbers to the handset without any cable connection.

One drawback of this arrangement lies in the fact that the transfer of the telephone numbers necessarily occurs using the two combined and separate elements which have to be close to each other to be able to establish a telephone link.

One object of the invention consists in overcoming the aforecited drawbacks of the prior art by proposing a method for telephone communication between a portable object, provided with horological functions and a mobile telephone unit, and a dedicated server to establish a two-way transmission of horological function signals for the purpose of allowing the horological functions of the portable object to be adjusted and/or updated at any geographical location and at any moment desired.

The aforecited telephone communication method is thus characterised in that it includes the steps of:

connecting the mobile telephone unit of the portable object to a cellular telephone network, the connection to said network allowing the geographical location of the portable object to be located;

establishing a telephone link between the server and the portable object;

transmitting data signals between the server and the portable object for adjusting and/or updating the horological functions of the object; and

correcting the horological functions of said object on the basis of the data signals which have been received and shaped.

One advantage of the method lies in the fact that it is possible, at any geographical location covered by the cellular telephone network, to adjust the local time, Internet time, date, Internet date, or update the horological functions of said portable object, by establishing a telephone link with a dedicated server. The connection of the portable object to the cellular telephone network allows it to be located geographically in the event that such information is necessary for the server to change the time zone.

It is thus not necessary to have to adjust particularly the time at fixed location depending on standard communication apparatus connected to telephone lines.

Another advantage of the method lies in the fact that the server can store all the time drifts of said object during several telephone connections between the server and the portable object particularly for resetting the time. The time differences after each time correction of the object are transmitted to the server during the same telephone link. Subsequently, the server can send updated data as a function of an evaluation of the time differences stored to act on the time base, for example on the frequency of the time-keeping circuit oscillator, or a chain division of the time-keeping circuit of the portable object in order to correct said object, from a distance, without it being necessary to go to a specialised shop to do so.

The telephone link between the server and the portable object, in particular in order to find out the operating state of said object, may advantageously occur at time intervals which are programmed either in the portable object or in the server. The portable object may for example store the server's telephone number which can be automatically dialled at time intervals defined by the person wearing the portable object.

Instead of providing data to correct certain horological functions of the watch, the server may simply warn the person using the portable object by sending him a short message informing him that he needs to return it to a specialised shop to have the time base adjusted precisely or certain defective horological functions updated.

The invention also concerns a portable object, such as a portable telephone-watch, which allows the telephone communication method to be implemented for the two-way transmission of radio-frequency signals carrying data relating to the horological functions of said object.

The portable object is as defined in claim 14.

The features and advantages of the invention will appear more clearly, in a non-limiting manner, in the following description of an embodiment illustrated by the drawings, in which:

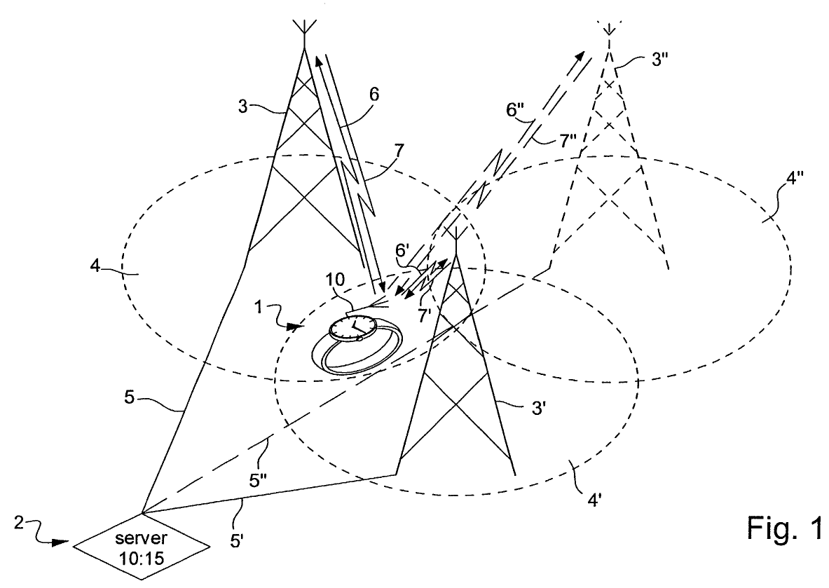

FIG. 1 shows a general schematic view of a mobile telephone network with the portable object, such as a telephone-watch, located in proximity to base stations connected to a dedicated server for transmitting data relating to the horological functions;

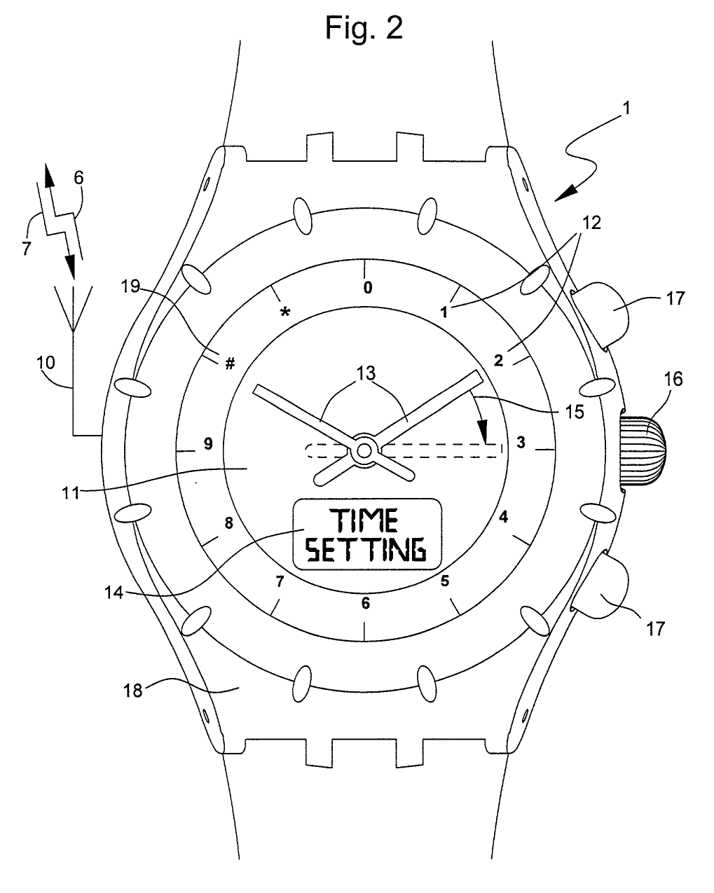

FIG. 2 shows a partial plan view of a telephone-watch for implementing the telephone communication method; and

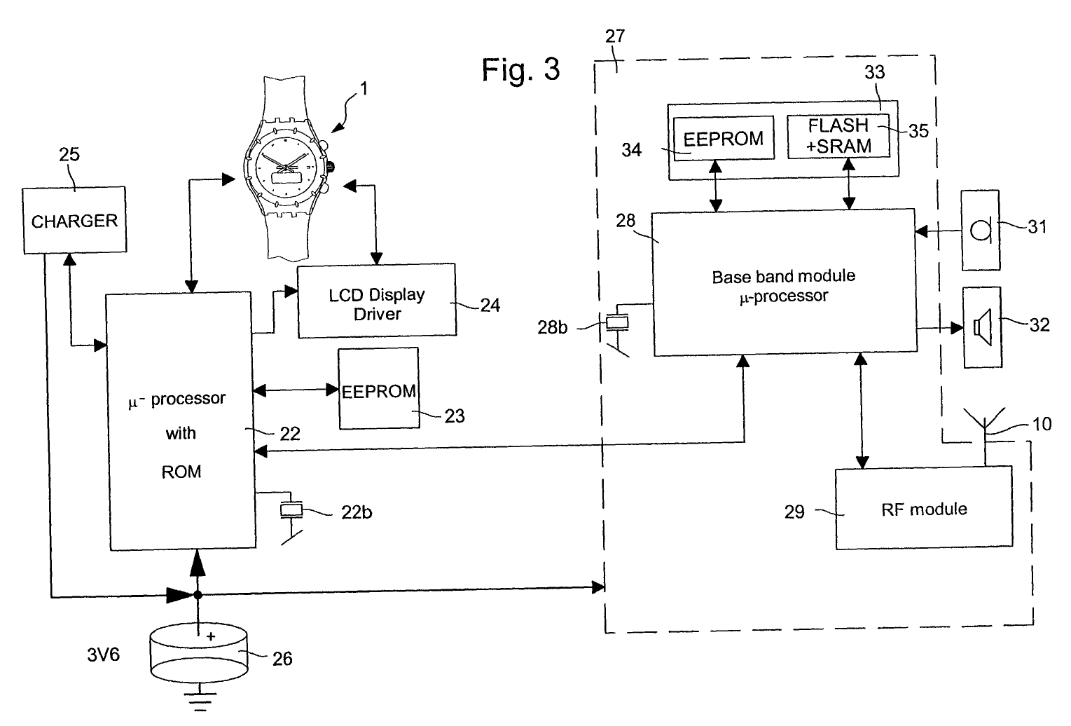

FIG. 3 shows schematically the different electronic units which are all integrated in the telephone-watch for implementing the telephone communication method.

In the following description, the portable object is only described in the preferred form of a telephone-watch which can be worn on a user's wrist without however be limited to this single embodiment, since the object could also be a mobile telephone or another object of comparable dimensions. The telephone-watch gives the wearer the advantage of leaving both of his hands free.

The telephone communication method, which is the subject of the invention, will be described hereinafter with reference to FIG. 1 which shows schematically the elements necessary to allow the exchange of data between a telephone-watch 1 and a dedicated server 2 which is defined precisely to act on the horological functions of the watch and also to transmit various announcements for example for events or things happening close to the person wearing the telephone-watch.

Telephone-watch 1 of the wristwatch type, whose various constituent elements will be described in the following description with reference to FIGS. 2 and 3, is worn on a user's wrist. This watch 1 includes a mobile telephone with an antenna 10 which, in basic operation, allows him to call a correspondent first of all by dialling his telephone number on said watch and then exchanging voice messages with his correspondent by using a microphone and a loudspeaker or earpiece integrated in the watch.

The signals transmitted 6, 6′ and 6″ and received 7, 7′ and 7″ by said telephone-watch are radio-frequency signals which pass through base stations 3, 3′ and 3″ operating across zones 4, 4′ and 4″ of a mobile telephone network. These base stations 3, 3′ and 3″ are connected by paths 5, 5′ and 5″ to a dedicated server 2 or telephone communication centre for the two-way transmission of data relating to the horological functions of said watch 1. In FIG. 1, only stations 3 and 3′ are in communication with the watch, which means that said watch can be detected by the two stations 3 and 3′ inside zones 4 and 4′ to define its geographic position.

The widespread type of network, which is preferably used in the present invention, is the digital cellular network designated GSM which currently operates around three carrier frequencies of the order of 900 MHz, 1800 MHz and 1900 MHz on which the data signals are modulated.

Time division multiple access (TDMA) and frequency division multiple access (FDMA) are used in the GSM standard. Two frequency bandwidths can be used for transmission and reception. For example, the first bandwidth for the 900 MHz standard is 880 to 915 MHz and the other bandwidth is from 925 to 960 MHz. Each band with is distributed over 175 channels having a frequency width of 200 kHz. Each channel allows 8 different telephone communications which are spaced in time by multiplexing. This means that the duration of each data frame transmitted during the same telephone communication represents an eighth of the time of the duration of a period separating two successive frames.

This distribution of communications over these frequency bands via multiplexing is generally sufficient for a multitude of telephone communications per region. However, a change of frequency (channel) may be made in the event of heavy occupation of one or other of the transmission channels, by using at least one base station through which the telephone communication passes. Moreover, in an agglomeration with a high population where for each base station too high a number of users prevents telephone communications being properly made, other standards, such as the DCS1800, may be used as a complement (1.8 GHz). This DCS1800 standard operates in TDMA and FDMA as for the previously described GSM. For more details on the mobile telephone networks, the reader may refer to the work entitled “Practical Cellular & PCS Design” by Clint Smith and edited by McGraw-Hill Telecommunications.

The use of mobile telephony on the GSM standard allows the location of the mobile telephone connected to the cellular network to be located relatively precisely. In the case of the present invention, telephone-watch 1 can be detected in a sufficiently well defined region.

With reference to FIG. 1, the telephone communication method consists in first of all connecting the telephone-watch to the mobile telephone network which would allow the location of the person wearing watch 1 to be located by its connection to at least one base station 3, 3′ or 3″. Following which, either the watch or the server manually or automatically dials the telephone number of the server or of the watch in order to automatically establish a telephone communication between the two. Once the telephone link has been established, server 2 sends adjusting and/or updating data for the horological watch functions to said watch.

In a simplified form or in a first telephone link with the specific watch, server 2 only transmits data for adjusting the local time indicated by the watch also taking into account its location detected with respect to the base stations in proximity to said telephone-watch 1 in order to define the right time zone. The server may also transmit data for adjusting the Internet time (date) or simply the date.

Upon receiving radio-frequency signals 7, 7′ carrying the local time adjustment data, telephone-watch 1 extracts from the radio-frequency signals the digital data necessary for adjusting the time. This adjustment data is provided to the microprocessor of the time-keeping circuit so that a correction between the exact time, represented by 10h15 on server 2, and the time indicated by the watch is made. The number of steps imposed on the stepping motor, in the case of an electronic watch of the analogue type, by the microprocessor to bring the time display hands of the watch into the exact time indicating position is calculated and stored. This time difference is transmitted 6, 6′ to server 2 so that it can store or index this correction time difference specific to said watch.

These time adjustments related to data exchange operations between the server and the watch can be repeated automatically at determined time intervals or on demand over time.

Preferably, telephone-watch 1 includes storage means in which are stored, in particular, the (free) telephone number of dedicated server 2. The user of telephone-watch 1 can also programme the time intervals at which he wishes the server's telephone number to be extracted from the storage means and automatically dialled to establish the telephone link with said server 2. These time intervals may for example be one or several hours, one or several days, one or several weeks, one or several months. Of course, said user can also dial said telephone number himself on said watch at any moment when he wishes to contact server 2.

After several operations for adjusting the time of the watch, server 2, which has indexed all the correction time differences provided by said watch with respect to the exact real time, can send a short message to said watch to inform the person wearing it that the operation of his watch has to be checked and advising him to take his watch to a specialised centre to check the horological functions if the correction time differences are deemed to be too long.

Instead of only sending a short information message as to time correction, it could also be envisaged for the server to be responsible for transmitting to the watch updating data allowing the operation of the electronic components of the time-keeping circuit to be acted upon. It is conceivable that in the data frame received by the telephone-watch, adjustment data (trimming) for the time base or the oscillator or the division chain of the time-keeping circuit allow the microprocessor of the time-keeping circuit to automatically correct the precision of the displayed time in a durable manner. This solution would mean that the wearer of the watch could avoid taking his watch to the specialised centre for repair.

Another solution would consist in sending, to the server data as to the frequency of the voltage pulses sent to the stepping micro-motor to drive the time indicating hands forward. A comparison is then made in the server between the pulse frequency and an exact frequency in order for the updating data to be transmitted to the watch to correct said pulse frequency.

The desired object of the embodiment described hereinabove consists in establishing statistics as to the corrections made in the server for several telephone-watches in order to inform each person wearing a telephone-watch during telephone communication established automatically or manually with the server. Instead of dialling the call from the watch to the server, said server could, at determined time intervals, call each telephone-watch individually connected to the mobile telephone network. The server then has to have all the particular watch telephone numbers stored in its memory.

During the telephone link between the server and the telephone-watch, other data can be exchanged. The server can for example send data to telecharge several musical melodies on the demand of the person wearing the watch. These musical melodies are stored in storage means of the watch in order to be able to choose a particular melody when an alarm is set off or for entertainment. This musical melody telecharging operation is considered as an update of a horological function of the watch.

The energy consumption of the watch may also be reduced during horological function data transmission by acting on modules of the time-keeping circuit or modifying a calculation module for several time zones.

Updating an electronic module of the watch providing for example the indication of several time zones may also be required from the server and transmitted during the telephone communication. Moreover, the server can also provide data for a change of display mode to pass from a 12 h display mode to a 24 h display mode for a telephone-watch of the digital type. There is a communication protocol which allows the various data provided by the server to be differentiated from the watch in order to find out which horological function is or has to be corrected or updated.

One may also envisage programming alarm functions or different tones in the server from the watch for particular occasions. Several applications can be controlled via the SIM card inserted in the telephone-watch.

During a telephone link with the server, telephone-watch 1 could transmit data thereto as to the state of its energy accumulator so that the server can warn the person wearing the watch when said accumulator is low, even if this function may generally be achieved within the watch.

In a different context to the adjustment and/or updating of the horological functions of the telephone-watch, the sever can establish a telephone link with or without the ringing tone intended for a particular telephone-watch or a set of telephone-watches located in a specific region in order to transmit thereto voice or text information as to local events or things which will take place in said region. Preferably, the watch has to include a liquid crystal display device for displaying the information messages received from the server.

For the implementation of the method described previously with reference to FIG. 1, the telephone-watch will be described in the following description with reference to FIGS. 2 and 3.

FIG. 2 shows an electronic telephone-watch of the analogue type seen in a plan view. Said electronic watch 1 is formed of a case 18, connected to both strands of an unreferenced wristband, a watch dial 11, placed under an unreferenced crystal, through which a shaft carrying the time indicating hands 13 passes, a crown 16 used in particular for adjusting the time and date displayed by the watch, buttons 17 for selecting, confirming or deleting selected data and a liquid crystal display device 14 for displaying messages or various other data such as the date for example.

Said watch comprises enclosed in case 18 an antenna 10, represented schematically in FIG. 2, for transmitting 6 and receiving 7 radio frequency signals during a telephone communication.

During the telephone communication, said watch receives, in particular, time setting data. In this case, data converted by said watch requires said time keeping microprocessor to correct the displayed time, i.e. 10:10 to the exact time 10:15, which is shown by the arrow referenced 15 on the dial and by the hand shown in dotted lines.

On the dial or under the crystal, the figures and signs 12 shown are used both as hour symbols and as telephone dial numbers. They are located on an indication ring 19. It is clear, however, that a specific set of numbers for time indication could also be added to the dial inside ring 19 in order to have, on the one hand, the telephone dial number figures and signs 12 and on the other hand the time indication figures.

An embodiment of the call number dialling means may include a keyboard formed of a plurality of capacitive sensors arranged under the watch crystal used by the user for dialling a telephone number by placing a finger on the surface of the crystal corresponding to the figure or sign which he wishes to dial.

European Patent No. 0 674 247, wherein the watch disclosed includes a case, a crystal and at least a manual control device including a capacitive sensor fitted with an electrode arranged on the inner face of the crystal, will be taken here by way of example. The selective positioning of a finger of the person wearing the watch on the external face of the crystal allows a capacitance to be formed between the electrode and earth formed by the watch case. This manual control device also includes a voltage-frequency converter whose oscillation frequency is determined by the aforementioned capacitance. The electrode is connected by a conductor to the converter which is housed in the case.

The keyboard in question may be intended to replace the usual external control means, such as push-buttons 17, for example used to control the various functions of a watch, such as time-setting or starting and stopping a chronograph. It will be understood, however, that this keyboard may also be used as a selector for dialling a telephone number if the watch is provided with a radio telephone as for the present invention.

Another embodiment of the telephone number dialling means may be taken as an example from European Patent No. 0 698 983. In this document, crown 16 can be arranged in three axial positions: the first, pressed in and unstable for the purposes in particular for confirming the figure selected in telephone mode, the second, neutral and stable for selecting said figure and the third, pulled out and stable, for setting the time of the time-keeping circuit. The reader can refer to this publication for further technical design details, in particular in order to understand the steps for dialling the telephone number to be called.

FIG. 3 shows the different electronic units which are all integrated in the case of wristwatch 1. The telephone-watch thus generally includes for the time-keeping functions, a microprocessor 22 clocked at a clock frequency of approximately 32 kHz provided by a quartz oscillator 22b, a non-volatile EEPROM memory 23 for storing data, a drive device for the LCD display 24, an accumulator 26 intended to provide a voltage of the order of 3.6 V for the electric power supply of the electronic watch components and an electric charger 25 for the accumulator. The microprocessor used may be for example the 8-bit PUNCH microprocessor by the company EM Microelectronic-Marin SA in Switzerland. EEPROM memory 23 is used for storing for example telephone numbers including that of the server.

Telephone-watch 1 also includes a telephone network interface 27 which is well known. This interface is formed of an RF module 29 connected to an antenna 10 for transmitting and receiving radio-frequency signals, a base band module 28 with a microprocessor, connected to module 29 and clocked for example by a quartz oscillator 28b supplying a frequency of 13 MHz, a memory unit 33 including an EEPROM memory 34 and a FLASH and SRAM memory 35 connected to module 28. In the memory unit, various data can be stored including also the server's telephone number.

Base band module 28 provides acoustic data of frequencies between 300 and 3.6 kHz to earpiece 32 and receives data in particular voice data from microphone 31. Said base band module manages to decipher the digital data signals provided at a frequency lower than 100 kHz at the output of RF module 29 in order to know how to shape the data to be directed towards the earpiece or to memory unit 33 or microprocessor 22 for adjusting and/or updating the horological functions or for transmitting messages to be displayed on the display device of the watch. The quantity of data controlled is of the order of 13 kbits/s, without limiting greater quantities. These data signals are conventional data frames with coding, synchronisation and actual data portions.

From the description which has just been given, multiple alternative embodiments of the telephonic communication method can be made without departing from the scope of the invention and within the knowledge of those skilled in the art. For example, the server may include, during a telephone link with the object with horological functions or the watch, means for storing the transmitted time of the object and means for making a comparison with the exact time in order to return to said object or watch only the time difference necessary for correcting the time. The information message signals as to the state of the horological functions, or as to events or things happening transmitted from the server to the portable object may also be audible messages instead of messages displayed on a display device of the portable object or watch.

What is claimed is:

1. A method for telephone communication between at least one portable object, which includes horological functions and a mobile telephone unit, and a dedicated server for the two-way transmission of horological function data signals, wherein it includes the steps of:
connecting the mobile telephone unit of the portable object to a cellular telephone network, the connection to said network allowing the geographical location of the portable object to be located;
establishing a telephone link between the server and the portable object;
transmitting data signals between the server and the portable object for adjusting and/or updating the horological functions of the object; and
correcting the horological functions of said object on the basis of the data signals which have been received and shaped.

2. The method according to claim 1, wherein once the telephone link is established between the server and the portable object, the server transmits signals for adjusting the local time, Internet time and/or date indicated by the portable object.

3. The method according to one of claims 1 and 2, wherein the portable object includes a microprocessor with a time-keeping circuit in which the time is indicated on a first display device, wherein the time of the first display is compared and corrected to an exact time provided by the server, and wherein a correction time difference between the time prior to correction and the exact time is transmitted to the server.

4. The method according to claim 3, wherein the server stores all the correction time differences which it receives from the portable object during several telephone links spaced over time, and wherein it transmits to the object, on the basis of the stored and evaluated time differences, data signals as to the state of its horological functions or adjustment data signals for updating the time base of the time-keeping circuit of the microprocessor.

5. The method according to claim 4, wherein the data signals as to the state of the horological functions transmitted by the server are messages which are displayed on the first display device or on a second display device during the telephone link to inform the person wearing the portable object as to the state of the horological functions of said object.

6. The method according to claim 1, wherein the portable object includes means for dialling manually or automatically at programmed intervals of time, the telephone number of the dedicated server, which is stored in storage means of the portable object, in order to establish the telephone link and in order to receive from the server the data signals for adjusting and/or updating its horological functions.

7. The method according to claim 1, wherein the server stores several telephone numbers each corresponding to a specific portable object to establish at determined intervals of time telephone links with each portable object and to adjust and update individually the horological functions of each portable object.

8. The method according to claim 1, wherein, during the established telephone link, data signals of a selected number of melodies are transmitted from the server to the portable object at the request of the person carrying the portable object to update a melody generating module of the object.

9. The method according to claim 1, wherein, during the established telephone link, data signals for programming an alarm are transmitted from the portable object to the server to require the server to call the portable object at a determined time interval.

10. The method according to claim 1, wherein information message signals as to events or things happening are transmitted from the server to the portable object as a function of the detected geographical location of the portable object in the mobile telephone network, said messages being displayed on a display device of the portable object.

11. The method according to claim 1, wherein time zone or display mode selection data signals are transmitted from the server to the portable object for updating a module for adjusting the time zones or a time display mode selection module to choose whether to display the time in 12 h or 24 h mode.

12. The method according to claim 1, wherein message or information signals are transmitted from the server to the portable object, which includes a display device for reading the messages, in order to provide it with information as to the state of its horological functions on the basis of adjustments and/or updates made to said horological functions over time.

13. The method according to claim 1, wherein the portable object is a telephone-watch, in particular a wristwatch including a mobile telephone, which includes storage means in which the number of the dedicated server is stored, wherein said number of the server is automatically dialled at intervals of time programmed by the user of said watch.

14. A portable object, in particular a portable telephone-watch, for implementing the method according to claim 1, said object including a microprocessor with a time-keeping circuit, a mobile telephone unit, means for dialling a telephone number, a microphone and an earpiece connected to said mobile telephone unit, and at least one display device for the time, date and/or messages, wherein it includes storage means in which a call number of a dedicated server providing horological function data signals is stored, and wherein the call number stored in the storage means is able to be dialled automatically in the mobile telephone unit at programmed time intervals to establish a telephone link with said server in order to receive signals for adjusting and/or updating the horological functions of said object.
